(19) United States
(12) Patent Application Publication
(10) Pub. No.: US 2024/0343641 A1
(43) Pub. Date: Oct. 17, 2024

(54) GLASS SUBSTRATE AND MANUFACTURING DEVICE FOR GLASS SUBSTRATE

(71) Applicant: AGC Inc., Tokyo (JP)

(72) Inventors: Kaede KATSUNO, Tokyo (JP); Yuha KOBAYASHI, Tokyo (JP); Kohei HORIUCHI, Tokyo (JP)

(73) Assignee: AGC Inc., Tokyo (JP)

(21) Appl. No.: 18/631,531

(22) Filed: Apr. 10, 2024

(30) Foreign Application Priority Data
Apr. 12, 2023 (JP) 2023-065214
Sep. 7, 2023 (JP) 2023-145586

(51) Int. Cl. C03C 23/00

(52) U.S. Cl. CPC C03C 23/0025

(57) ABSTRACT

To provide a glass substrate having a surface on which a mark constituted of a plurality of dots is disposed. The dot includes an indentation part as a portion depressed from the surface, and a projecting part projecting from the indentation part in a thickness direction of the glass substrate. The projecting part extends at a position overlapping a contour of the dot or on an inner side than the contour.

### CROSS-REFERENCE TO RELATED APPLICATIONS

The present application claims priority to and incorporates by reference the entire contents of Japanese Patent Application No. 2023-065214 filed in Japan on Apr. 12, 2023 and Japanese Patent Application No. 2023-145586 filed in Japan on Sep. 7, 2023.

### BACKGROUND OF THE INVENTION

### 1. Field of the Invention

The present invention relates to a glass substrate and a manufacturing device for the glass substrate.

### 2. Description of the Related Art

A glass substrate may be used as a member for supporting a semiconductor device during a manufacturing process for a semiconductor device. For example, as disclosed in Japanese Patent Application Laid-open No. 2016-210644, a mark may be formed on a surface of such a glass substrate by irradiating the surface of the glass substrate with laser light to engrave a seal thereon. The mark on the surface of the glass substrate is read by a code reader and the like. In this case, the mark is required to be reliably read. Thus, it is required to form a mark to be easily read.

The present invention is made in view of the problem described above, and aims at providing a glass substrate with which a mark can be easily read.

### SUMMARY OF THE INVENTION

It is an object of the present invention to at least partially solve the problems in the conventional technology.

The manufacturing device for a glass substrate of the present disclose is configured to dispose a mark constituted of a plurality of dots on a surface of the glass substrate, the manufacturing device comprising: a laser oscillator configured to oscillate laser light that forms a dot on the glass substrate, and a mask disposed on an optical path of the laser light connecting the laser oscillator with the glass substrate, wherein the mask includes a transmission pattern including a transmission part through which the laser light is transmitted and a shielding part that blocks the laser light, and the shielding part extends at a position overlapping a contour of the transmission pattern or on an inner side than the contour in a plan view viewed from a direction along the optical path of the laser light.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a glass substrate according to an embodiment;

FIG. 2 is a schematic diagram of an example of a mark;

FIG. 3 is a schematic enlarged view of a portion of the glass substrate where a dot is formed;

FIG. 4 is a cross-sectional view along a line IV-IV in FIG. 3;

FIG. 5 is a schematic enlarged view of a portion of the glass substrate where a dot is formed according to a first modification of the present embodiment;

FIG. 6 is a schematic enlarged view of a portion of the glass substrate where a dot is formed according to a second modification of the present embodiment;

FIG. 7 is a schematic enlarged view of a portion of the glass substrate where a dot is formed according to a third modification of the present embodiment;

FIG. 8 is a schematic enlarged view of a portion of the glass substrate where a dot is formed according to a fourth modification of the present embodiment;

FIG. 9 is a schematic enlarged view of a portion of the glass substrate where a dot is formed according to a fifth modification of the present embodiment;

FIG. 10 is a schematic enlarged view of a portion of the glass substrate where a dot is formed according to a sixth modification of the present embodiment;

FIG. 11 is a schematic enlarged view of a portion of the glass substrate where a dot is formed according to a seventh modification of the present embodiment;

FIG. 12 is a schematic enlarged view of a portion of the glass substrate where a dot is formed according to an eighth modification of the present embodiment;

FIG. 13 is a schematic enlarged view of a portion of the glass substrate where a dot is formed according to a ninth modification of the present embodiment;

FIG. 14 is a schematic diagram of a manufacturing device for the glass substrate according to the present embodiment; and

FIG. 15 is a schematic plan view of a mask according to FIG. 14.

### DETAILED DESCRIPTION OF THE PREFERRED EMBODIMENTS

The following describes a preferred embodiment of the present invention in detail with reference to the attached drawings. The present invention is not limited to the embodiment, and in a case in which there are a plurality of embodiments, the embodiments may be combined with each other. Numerical values encompass rounded numerical values.

### Glass Substrate

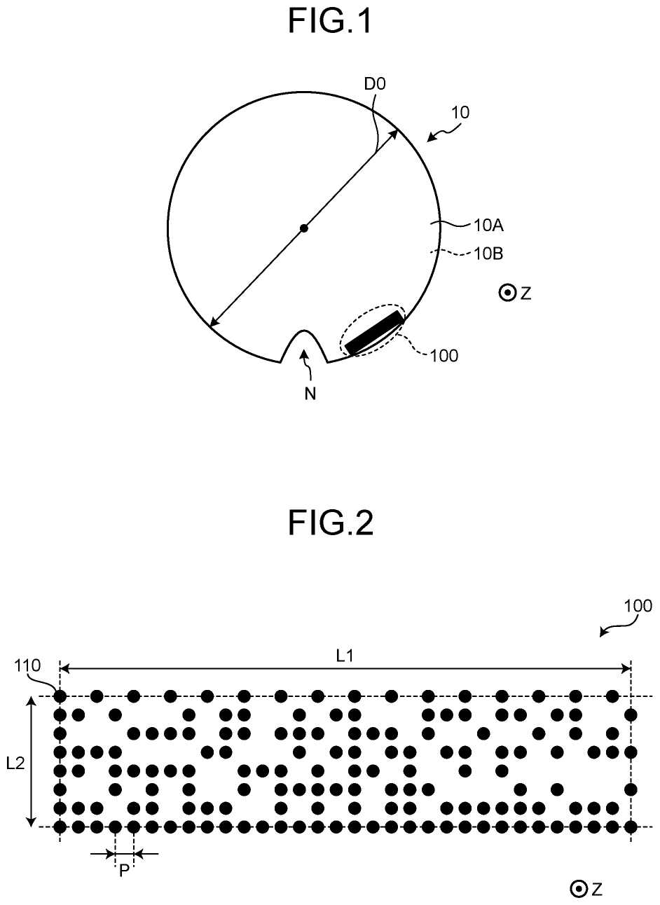

FIG. 1 is a schematic diagram of a glass substrate according to the present embodiment. A glass substrate 10 according to the present embodiment is used as a glass substrate for manufacturing a semiconductor package, and can be said to be a glass substrate for supporting a semiconductor device. More specifically, the glass substrate 10 is a support glass substrate for manufacture using a Fan Out Wafer Level Package (FOWLP) technique. For example, in a case in which the glass substrate 10 has a rectangular shape, the glass substrate 10 is a support glass substrate for manufacturing a Fan Out Panel Level Package (FOPLP). However, a use of the glass substrate 10 is not limited to supporting the semiconductor device and manufacturing the FOWLP or the FOPLP, but is optional. The glass substrate 10 may be a glass substrate used for supporting an optional member. Additionally, the glass substrate 10 may be cover glass for an image sensor, or glass or crystallized glass processed to be an optional product such as a substrate for a semiconductor device.

As illustrated in FIG. 1, the glass substrate 10 is a plate-shaped member including a surface 10A (one surface) as a principal plane on one side and a surface 10B (another surface) as a principal plane on the opposite side of the surface 10A. The glass substrate 10 has a disc shape, which is a circular shape, in a plan view, that is, when viewed from a direction orthogonal to the surface 10A. In other words, the glass substrate 10 has a wafer shape. Alternatively, a notch part N may be formed on an outer peripheral surface of the glass substrate 10, and the glass substrate 10 may have a shape obtained by partially notching an outer circumference of the circular shape. However, the shape of the glass substrate 10 is not limited to the disc shape but may be an optional shape. For example, the glass substrate 10 may be a plate having a polygonal shape such as a rectangular plate shape. Additionally, the notch part N is not an essential configuration, so that the notch part N is not necessarily formed on the glass substrate 10. For example, in a case in which the glass substrate 10 has a circular plate shape as described later, the notch part N is preferably formed.

Hereinafter, a direction orthogonal to the surface 10A is referred to as a Z-direction. It can also be said that the Z-direction is a thickness direction of the glass substrate 10.

### Diameter of Glass Substrate

A diameter DO of the glass substrate 10 is preferably equal to or larger than 20 mm and equal to or smaller than 1000 mm, preferably equal to or larger than 150 mm and equal to or smaller than 700 mm, more preferably equal to or larger than 150 mm and equal to or smaller than 600 mm, and even more preferably equal to or larger than 150 mm and equal to or smaller than 450 mm. By causing the diameter D0 to fall within this range, a member such as a semiconductor device can be appropriately supported. The diameter D0 indicates a diameter in a case in which the glass substrate 10 has a circular shape. However, in a case in which the glass substrate 10 does not have the circular shape, the diameter D0 may indicate a maximum value of a distance between optional two points on an outer periphery of the glass substrate 10.

In a case in which the glass substrate 10 has a disc shape, the diameter D0 is preferably equal to or smaller than 450 mm, and more preferably equal to or smaller than 300 mm.

In a case in which the glass substrate 10 has a rectangular plate shape, the diameter D0, that is, a length of a diagonal line as a maximum value of a distance between optional two points on the outer periphery of the glass substrate 10 is preferably equal to or larger than 30 mm and equal to or smaller than 1000 mm.

### Thickness of Glass Substrate

A thickness of the glass substrate 10, that is, a length in the Z-direction between the surface 10A and the surface 10B, is preferably equal to or smaller than 2 mm, more preferably equal to or larger than 0.05 mm and equal to or smaller than 2.0 mm, even more preferably equal to or larger than 0.5 mm and equal to or smaller than 2.0 mm, even more preferably equal to or larger than 0.5 mm and equal to or smaller than 1.8 mm, and yet more preferably equal to or larger than 0.6 mm and equal to or smaller than 1.5 mm. By causing the thickness of the glass substrate 10 to be equal to or smaller than 2 mm, it is possible to suppress handling difficulty due to an increase in weight. By causing the thickness to be larger than 0.3 mm, it is possible to increase rigidity at the time of being used as a supporting member, and suppress warpage of glass or a semiconductor device.

In a case in which the glass substrate 10 has a disc shape, the thickness is preferably equal to or larger than 0.3 mm and equal to or smaller than 2.0 mm, and in a case in which the glass substrate 10 has a rectangular plate shape, the thickness is preferably equal to or larger than 0.5 mm and equal to or smaller than 2.0 mm.

A deviation of the thickness of the glass substrate 10 is preferably equal to or smaller than 50 μm, more preferably equal to or smaller than 5 μm, even more preferably equal to or smaller than 3 μm, and yet more preferably equal to or smaller than 1 μm. By causing the deviation of the thickness to fall within this range, the thickness of the glass substrate 10 approaches a uniform thickness, the semiconductor device can be appropriately manufactured, and stable processing can be performed in forming the mark. The deviation of the thickness indicates a difference between a maximum value and a minimum value of the thickness at respective positions (coordinates) on a plane along the surface of the glass substrate 10. For example, the thickness may be calculated for each position (coordinates) on the plane along the surface of the glass substrate 10, and a difference between the maximum value and the minimum value of the thickness at the respective positions may be assumed to be the deviation of the thickness.

A Local Thickness Variation (LTV) in a 50 mm square of the glass substrate 10 is preferably equal to or smaller than 25 μm, and more preferably equal to or smaller than 10 μm. The LTV in a 50 mm square indicates a difference between the maximum value and the minimum value of the thickness in a unit region of a 50 mm square at an optional position on the glass substrate 10. In other words, the deviation of the thickness is a difference between the maximum value and the minimum value of the thickness in the entire region of the glass substrate 10, but the LTV indicates a difference between the maximum value and the minimum value of the thickness in the unit region of the glass substrate 10.

### Mark

On the surface 10A of the glass substrate 10, a mark 100 is formed. The mark 100 may be, for example, an identifier constituted of at least one of a numeral, a character, a two-dimensional code, and a figure. The number of numerals, characters, two-dimensional codes, and figures may be one or multiple. It can be said that the mark 100 as the identifier is a mark for identifying the glass substrate 10. The mark 100 as the identifier can be used for identifying and managing the glass substrate 10, for example.

The mark 100 is not limited to the identifier for identifying the glass substrate 10, but may be an alignment mark, for example. The alignment mark is, for example, a mark for positioning the glass substrate 10, and can be used for aligning a position or a direction of the glass substrate 10 at the time of handling thereof or performing processing such as cutting, chamfering, and bonding thereon. The mark 100 may be a mark for determining orientation of the glass. That is, at the time of laminating a device and the like on the glass substrate 10, the mark 100 may be formed on an opposite surface of a surface on which the device and the like are laminated corresponding to variation of warpage at the time of manufacturing the device and the like.

FIG. 2 is a schematic diagram of an example of the mark. In the example of FIG. 2, the mark 100 is a data matrix defined by SEMI-T7-0709. More specifically, the mark 100 is a mark representing data by presence/absence of dots 110 disposed in cells of 8 rows by 32 columns arranged in a rectangular shape. That is, by reading the mark 100 by a code reader and the like, the data represented by the mark 100 can be acquired. The mark 100 is read by irradiating the mark 100 with light, imaging the mark 100, and binarizing and decoding obtained imaging data. The mark 100 is not limited to the data matrix defined by SEMI-T7-0709, but may represent optional information for identifying the glass substrate 10.

Overall dimensions of the mark 100 are not particularly limited, and defined based on types of a font and a two-dimensional code. For example, in a case of the mark 100 as illustrated in FIG. 2, a length L1 in a lateral direction and a length L2 in a vertical direction are defined by SEMI-T7-0709. Herein, the lateral direction indicates a direction in which the rows extend, and the vertical direction indicates a direction in which the columns extend. Specifically, the length L1 in the lateral direction falls within a range of 3.88±0.05 mm, and the length L2 in the vertical direction is 0.88±0.05 mm. The length L1 in the lateral direction indicates a distance in the lateral direction between the center of the dot 110 closest to one side in the lateral direction of the mark 100 and the center of the dot 110 closest to another side in the lateral direction, and the length L2 in the vertical direction indicates a distance in the vertical direction between the center of the dot 110 closest to one side in the vertical direction of the mark 100 and the center of the dot 110 closest to another side in the vertical direction.

The mark 100 is constituted of a plurality of the dots 110. In other words, the mark 100 is formed of the dots 110. In the present embodiment, the dots 110 do not overlap with each other, and are formed to be separated from each other. For example, a pitch P between the adjacent dots 110 is defined by SEMI-T7-0709, and defined based on types of a font and a two-dimensional code. The pitch P indicates a distance between the center of one dot 110 and the center of the dot 110 adjacent to the former dot 110 in a direction along the surface 10A.

In the following description, a matching level is an indicator indicating ease of reading the mark 100 as a numerical value equal to or larger than 0 and equal to or smaller than 100. Herein, a reading rate indicates a ratio of the number of times when data represented by the mark 100 is successfully acquired to the number of times of reading the mark 100 in a case of reading the mark 100 multiple times. The matching level can be measured by a reader such as Keyence SPX300, for example. For example, the matching level can be measured by setting a distance between the mark 100 and the reader to be 8 cm, and setting a reading angle for the surface 10A of the glass substrate 10 to be 30°.

### Dot

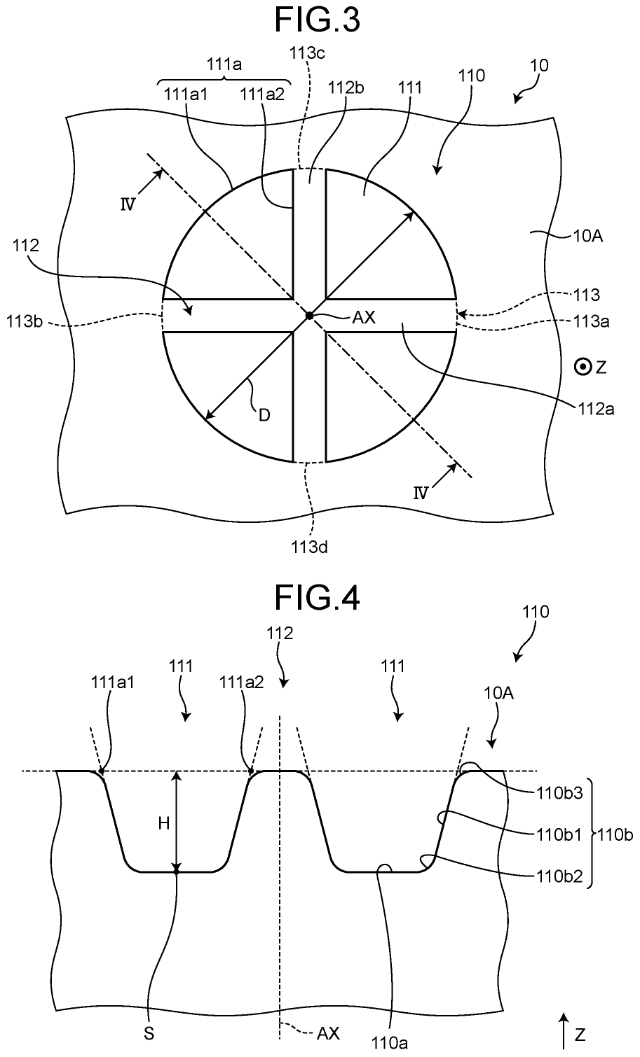

FIG. 3 is a schematic enlarged view of a portion of the glass substrate where the dot is formed, and FIG. 4 is a cross-sectional view along a line IV-IV in FIG. 3. It can be said that FIG. 4 is a cross-sectional view of the glass substrate 10 assuming that a cross section is a plane passing through the dot 110 and extending along the Z-direction. As illustrated in FIG. 3 and FIG. 4, the dot 110 includes an indentation formed on the surface 10A of the glass substrate 10. In the present embodiment, the dot 110 is formed by irradiating the surface 10A with laser light. That is, it can be said that the dot 110 in the present embodiment is a laser irradiation trace (irradiation trace of laser light).

As illustrated in FIG. 3, the dot 110 includes an indentation part 111 and a projecting part 112.

### Indentation Part

The indentation part 111 is a portion of the dot 110 depressed from the surface 10A. The indentation part 111 is depressed from the surface 10A in a direction from the surface 10A toward the surface 10B along the Z-direction. That is, it can be said that the indentation part 111 is a recessed part of the laser irradiation trace.

As illustrated in FIG. 4, the dot 110 includes a bottom surface 110a and a side surface 110b, and it can be said that the indentation part 111 is formed of a space surrounded by the bottom surface 110a and the side surface 110b. The bottom surface 110a indicates a surface depressed from the surface 10A in the direction from the surface 10A toward the surface 10B along the Z-direction. The side surface 110b indicates a side surface portion connecting the bottom surface 110a of the dot 110 and the surface 10A of the glass substrate 10. The side surface 110b includes a side surface part 110b1, a connection part 110b2, and a connection part 110b3. The side surface part 110b1 is a portion forming the side surface of the dot 110. The connection part 110b2 is a portion formed at an end part of the side surface part 110b1 on one side of the Z-direction, and has an R-shape connecting the bottom surface 110a and the side surface part 110b1. The connection part 110b3 is a portion formed at an end part of the side surface part 110b1 on the other side of the Z-direction, and has an R-shape connecting the side surface part 110b1 and the surface 10A of the glass substrate 10. However, the side surface 110b does not necessarily include the connection parts 110b2 and 110b3 having the R-shape. A connecting portion between the bottom surface 110a and the side surface part 110b1 and a connecting portion between the side surface part 110b1 and the surface 10A of the glass substrate 10 may have a shape including an edge.

A depth H of the indentation part 111 is preferably equal to or larger than 0.1 110b1 m and equal to or smaller than 30 um, more preferably equal to or larger than 0.5 110b1 m and equal to or smaller than 10 110b1 m, and even more preferably equal to or larger than 1 110b1 m and equal to or smaller than 6 110b1 m. By causing the depth H to fall within this range, a fracture of the glass substrate 10 starting from the indentation part 111 can be suppressed, and ease of reading can be secured. Herein, the depth H indicates a distance between the surface 10A and the bottom surface 110a in the Z-direction.

The depth H of the indentation part 111 is measured by the following method. Regarding the dot 110 of the mark 100, a cross-sectional shape of an optional one of the dots 110 is measured by a laser microscope. Subsequently, the lowest point of the cross section is assumed to be S, and a difference between the surface 10A as a glass main surface and the lowest point S in the Z-direction is assumed to be the depth H. However, in a case of a form having a concave shape in the vicinity of an outer peripheral edge 111a1 (described later), a depression in the vicinity of the outer peripheral edge 111a1 does not need to be taken into account as the lowest point. For example, the depth H can be measured by a laser microscope such as VK-X1000 manufactured by Keyence Corporation.

Assuming that AH indicates a deviation of the depth of the bottom surface 110a excluding a depression generated on a radially inner side of the bottom surface 110a, AH is preferably equal to or smaller than 50% of the depth H, and more preferably equal to or smaller than 25% thereof.

### Peripheral Edge

Herein, a boundary line between the side surface 110b of the indentation part 111 and the surface 10A is assumed to be a peripheral edge 111a of the indentation part 111. For example, the peripheral edge 111a may be a virtual line formed by a surface along the side surface part 110b1 and a plane along the surface 10A intersecting with each other. In other words, the peripheral edge 111a may correspond to a straight line passing through the side surface part 110b1 on a cross section viewed from each direction orthogonal to the Z-direction (for example, a line connecting respective intersection points of straight lines passing through the side surface part 110b1 and the surface 10A).

Herein, in a case in which the center of the dot 110 viewed from the Z-direction is assumed to be a center AX, and an axis passing through the center AX along the Z-direction is assumed to be a center axis, a radial direction is simply referred to as a “radial direction”. The center AX may be a geometric centroid of a figure obtained by totaling indentation parts 111. In this case, part of the peripheral edge 111a of the indentation part 111 on an outer side in a radial direction is assumed to be the outer peripheral edge 111a1. More specifically, among all sections of the peripheral edge 111a, a section on the radially outer side of which other sections of the peripheral edge 111a are not present is assumed to be the outer peripheral edge 111a1. In other words, neither the indentation part 111 nor the peripheral edge 111a of the same dot 110 is present on the radially outer side of a point on the outer peripheral edge 111a1. The indentation part 111 and the peripheral edge 111a of the other dot 110 may be present on the radially outer side of the outer peripheral edge 111a1.

In the following description, part of the peripheral edge 111a of the indentation part 111 other than the outer peripheral edge 111a1 is assumed to be an inner peripheral edge 111a2. In other words, the indentation part 111 or the peripheral edge 111a of the indentation part 111 of the same dot 110 is present on the radially outer side of a point on the inner peripheral edge 111a2.

In the example of FIG. 3, a shape of the indentation part 111 is four quadrants in a plan view in the Z-direction. The four quadrants are arranged so that the shape of the indentation part 111 is rotationally symmetric while right angles are oriented inward. Thus, in this case, a circular arc portion of the peripheral edge 111a is the outer peripheral edge 111a1, and a linear portion of the peripheral edge 111a is the inner peripheral edge 111a2.

Herein, assuming that a ratio of a length of the inner peripheral edge 111a2 to a length of the outer peripheral edge 111a1 (length of the inner peripheral edge 111a2/length of the outer peripheral edge 111a1) is A, A is preferably larger than 0.2 and smaller than 50, more preferably equal to or larger than 0.34 and equal to or smaller than 16.8, and even more preferably equal to or larger than 0.69 and equal to or smaller than 16.8. The length of the inner peripheral edge 111a2 indicates a total length of inner peripheral edges 111a2 of all of the indentation parts 111 included in one dot 110, and the length of the outer peripheral edge 111a1 indicates a total length of outer peripheral edges 111a1 of all of the indentation parts 111 included in one dot 110. That is, in the example of FIG. 3, the length of the inner peripheral edge 111a2 is the total length of linear portions of the four quadrants, and the length of the outer peripheral edge 111a1 is the total length of circular arc portions of the four quadrants.

Herein, A becomes a larger value as the inner peripheral edge 111a2 becomes longer than the outer peripheral edge 111a1, so that it can be said that A is an indicator indicating a degree of unevenness of the dot 110. Thus, by causing A to fall within this range, ease of reading can be improved.

The length of the outer peripheral edge 111a1 and the length of the inner peripheral edge 111a2 are measured by a laser microscope such as VK-X1000 manufactured by Keyence Corporation, for example.

### Contour

The following describes a contour 113 of the dot 110. The contour of the dot 110 indicates an outer peripheral edge of the dot 110, which is a closed line including the outer peripheral edges 111a1. For example, the contour 113 may be a closed line overlapping all of the sections of the outer peripheral edges 111a1 of all of the indentation parts 111 when viewed from the Z-direction. For example, the contour 113 of the dot 110 is preferably a line satisfying all of the following (1) to (4). (1) The line overlaps at least part of the outer peripheral edges 111a1 in a plan view in the Z-direction. (2) The longest distance between two points on the line is equal to the longest distance between two points on the outer peripheral edges 111a1 of the dot 110. (3) The line is a simple closed convex curve. (4) A region enclosed by the line overlaps all of the indentation parts 111. Herein, the simple closed convex curve is a closed line that does not self-intersect, which means that a line segment connecting optional two points inside the line or on the line does not overlap the outside of the line.

In the example of FIG. 3, a circumference of a circle having a diameter D centered on the center AX (1) overlaps all of the outer peripheral edges 111a1 (circular arc portions of the peripheral edges 111a) of the indentation parts 111, and (2) the longest distance between two points on the circumference is D, which is equal to the longest distance between two points on the outer peripheral edges 111a1. (3) The circumference is the contour of the circle, so that it is a simple closed convex curve. (4) The circle enclosed by the circumference overlaps all of the indentation parts 111. Thus, it can be said that the circumference of the circle having a radius R centered on the center AX is the contour 113 of the dot 110.

In the following description, a shape of a range enclosed by the contour 113 of the dot 110 is assumed to be a shape of the dot 110. In the example of FIG. 3, the shape of the dot 110 is a circular shape.

Herein, the diameter D of the dot 110 is preferably equal to or larger than 10 μm and equal to or smaller than 200 um, more preferably equal to or larger than 80 μm and equal to or smaller than 150 μm, and even more preferably equal to or larger than 90 μm and equal to or smaller than 120 μm. Herein, the diameter D of the dot 110 indicates the longest distance between two points on the contour 113 of the dot 110, that is, the longest distance between two points on the outer peripheral edges 111a1. By causing the diameter D of the dot 110 to fall within this range, the size of one dot 110 can be relatively large, and the mark 100 can be appropriately visually recognized.

### Projecting Part

The projecting part 112 is a portion projecting from the indentation part 111. In other words, the projecting part 112 indicates a portion of the dot 110 closer to the surface 10A side than the indentation part 111 in the Z-direction, that is, indicates a portion closer to the surface 10A side than the indentation part 111 in the Z-direction in a region on a radially inner side than the contour 113. More specifically, the projecting part 112 indicates a region other than the indentation part 111 of the dot 110 in a plan view in the Z-direction. In the present embodiment, it can be said that the projecting part 112 is a protruding part of a laser irradiation trace of the dot 110. The projecting part 112 extends at a position overlapping the contour 113 of the dot or on a radially inner side of the contour 113 of the dot. More specifically, on the projecting part 112, a first position and a second position are present as two different positions on the projecting part 112. Both of the first position and the second position are present at positions overlapping the contour 113 of the dot or on the radially inner side of the contour 113 of the dot. A path connecting the first position and the second position is present, the entire section of the path overlapping the projecting part 112. The projecting part 112 extends from a position overlapping the contour 113 of the dot toward the radially inner side of the contour 113. That is, it can be said that the line constituting the outer peripheral edge 111a1 of the indentation part 111 is not a closed line, but is a line at least one point of which is opened via the projecting part 112.

The projecting part 112 preferably extends from a first position 113a on the contour 113 to a second position 113b different from the first position 113a on the contour 113 while passing through the region on the radially inner side of the contour 113, in other words, the projecting part 112 preferably passes through two points on the contour 113. In the example of FIG. 3, the projecting part 112 has a cross shape extending from four positions overlapping the contour 113 of the dot 110 toward an inner side than the contour 113. In other words, in the example of FIG. 3, a first projecting part 112a extending from the first position 113a overlapping the contour 113 to the second position 113b and a second projecting part 112b extending from a third position 113c overlapping the contour 113 to a fourth position 113d are formed, and the first projecting part 112a and the second projecting part 112b intersect with each other in a region on the radially inner side of the contour 113.

The dot 110 according to the present embodiment has been described above. However, the dot according to the present invention is not limited to the dot 110 according to FIG. 3, but may be a dot according to modifications described below.

FIG. 5 is a schematic enlarged view of a portion of the glass substrate where a dot is formed according to a first modification of the present embodiment. As illustrated in FIG. 5, a projecting part 112A of a dot 110A according to the first modification has a grid shape. More specifically, the dot 110A according to the first modification is a dot with a contour 113A having a circular arc shape. Two projecting parts 112A are formed in each of the vertical direction and the lateral direction, and a remaining portion is divided into nine indentation parts 111A.

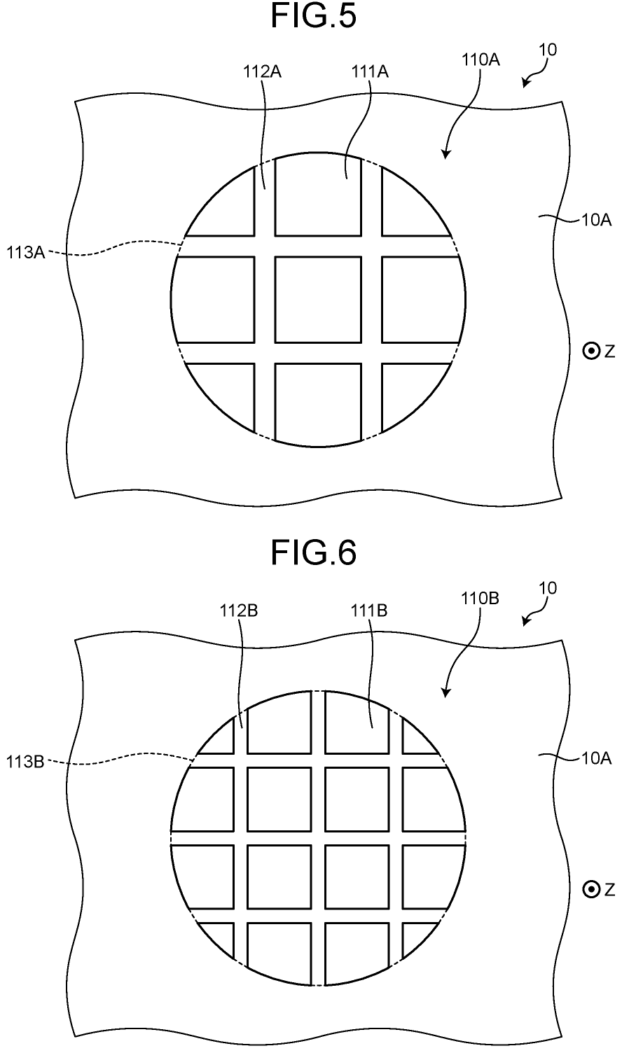

FIG. 6 is a schematic enlarged view of a portion of the glass substrate where a dot is formed according to a second modification of the present embodiment. As illustrated in FIG. 6, a projecting part 112B of a dot 110B according to the second modification has a grid shape. More specifically, the dot 110B according to the second modification is a dot with a contour 113B having a circular arc shape. Three projecting parts 112B are formed in each of the vertical direction and the lateral direction, and a remaining portion is divided into sixteen indentation parts 111B.

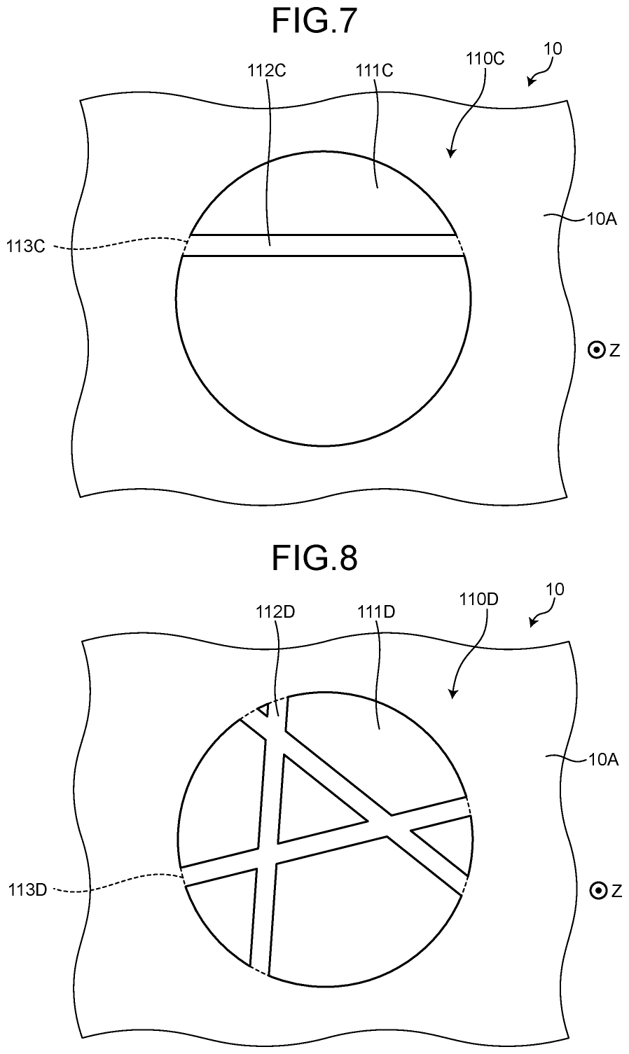

FIG. 7 is a schematic enlarged view of a portion of the glass substrate where a dot is formed according to a third modification of the present embodiment. As illustrated in FIG. 7, a dot 110C according to the third modification is a dot with a contour 113C having a circular arc shape, and a projecting part 112C has a belt shape. That is, the projecting part 112C passes through two points on the contour 113C of the dot 110C.

FIG. 8 is a schematic enlarged view of a portion of the glass substrate where a dot is formed according to a fourth modification of the present embodiment. As illustrated in FIG. 8, a dot 110D according to the fourth modification is a dot with a contour 113D having a circular arc shape, and a shape of a projecting part 112D is neither rotationally symmetric nor linearly symmetric. That is, positions where the projecting part 112D overlaps the contour 113D of the dot 110D are not at regular intervals.

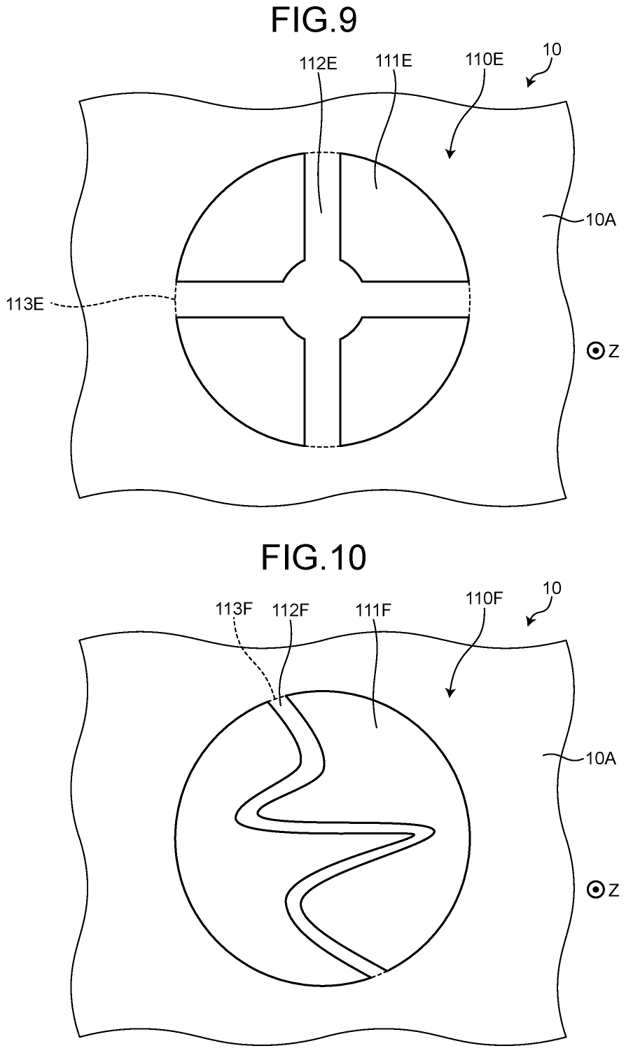

FIG. 9 is a schematic enlarged view of a portion of the glass substrate where a dot is formed according to a fifth modification of the present embodiment. As illustrated in FIG. 9, a dot 110E according to the fifth modification is a dot with a contour 113E having a circular arc shape. A projecting part 112E includes a cross-shaped portion each line of which is formed in the vertical direction and the lateral direction and a circular portion formed at an intersecting point of the cross-shaped portion, and remaining portions are indentation parts 111E.

FIG. 10 is a schematic enlarged view of a portion of the glass substrate where a dot is formed according to a sixth modification of the present embodiment. As illustrated in FIG. 10, a dot 110F according to the sixth modification is a dot with a contour 113F having a circular arc shape, and a projecting part 112F does not have a linear belt shape.

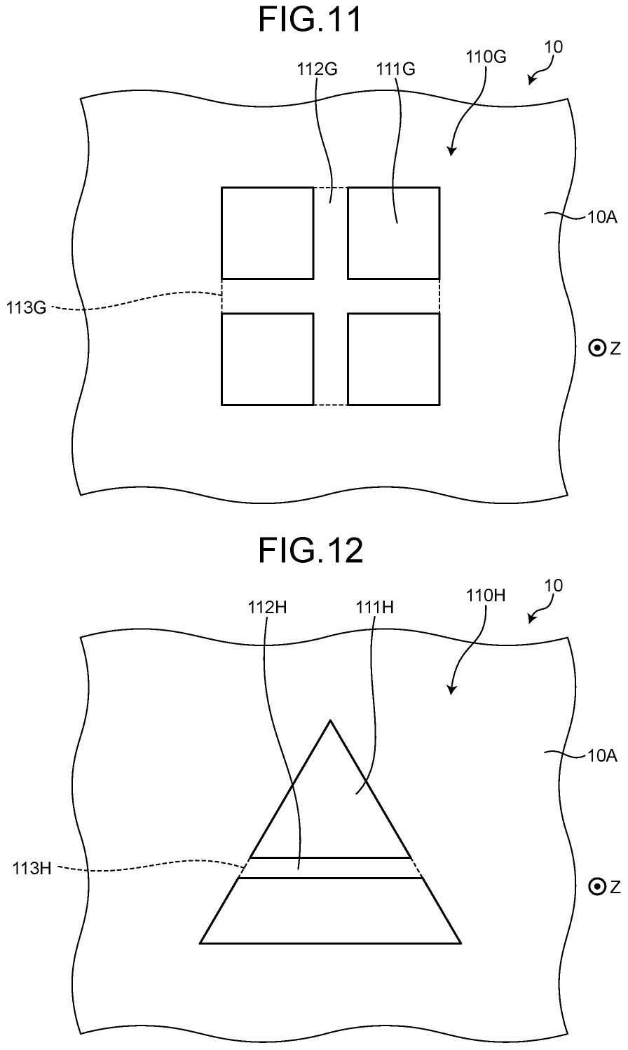

FIG. 11 is a schematic enlarged view of a portion of the glass substrate where a dot is formed according to a seventh modification of the present embodiment. As illustrated in FIG. 11, a dot 110G according to the seventh modification has a rectangular-shaped contour 113G. An indentation part 111G has a rectangular shape, and a projecting part 112G has a cross shape, but they are merely examples.

FIG. 12 is a schematic enlarged view of a portion of the glass substrate where a dot is formed according to an eighth modification of the present embodiment. As illustrated in FIG. 12, a dot 110H according to the eighth modification has a triangular-shaped contour 113H. An indentation part 111H has a triangular or trapezoidal shape, and a projecting part 112H has a belt shape, but they are merely examples.

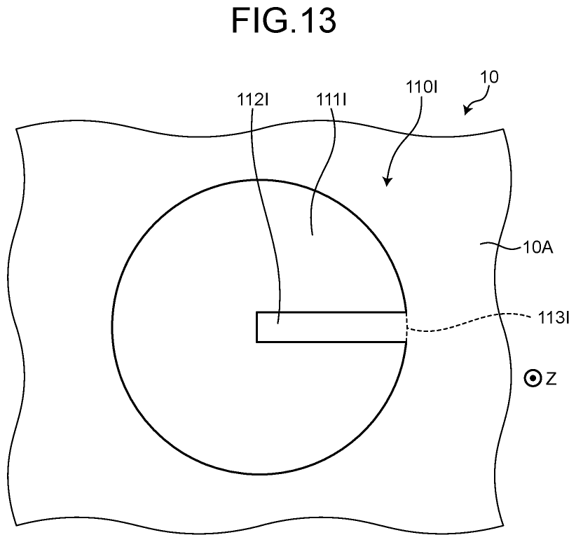

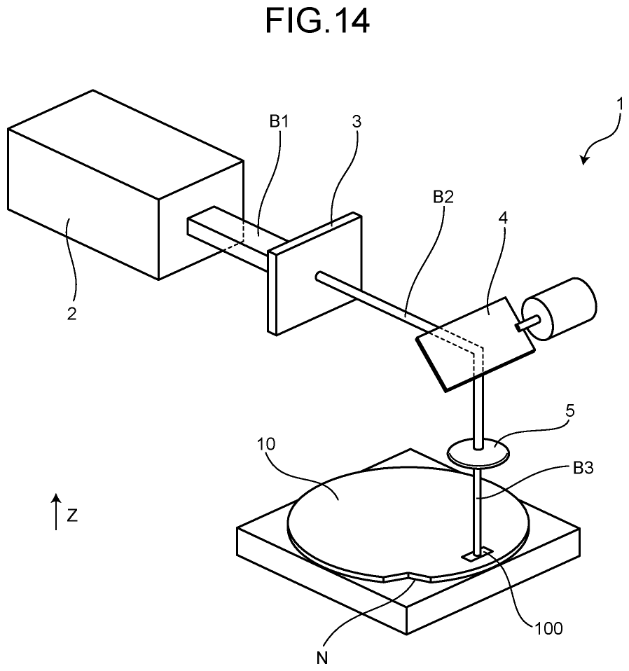

FIG. 13 is a schematic enlarged view of a portion of the glass substrate where a dot is formed according to a ninth modification of the present embodiment. As illustrated in FIG. 13, a dot 110I according to the ninth modification has a circular arc-shaped contour 113I, and a projecting part 112I has a shape extending from one position overlapping the contour 113I of the dot 110I toward an inner side than the contour 113I. That is, an indentation part 111I is not divided into a plurality of parts by the projecting part 112I.

The shapes of the dots 110A to 110I according to the first to the ninth modifications have been described above, but the shape of the dot according to the present embodiment is not limited to the examples described above. For example, the number of the projecting parts may be different from that in the modifications described above, and the dot may have a polygonal-shaped contour including five or more apexes.

### Method for Manufacturing Glass Substrate

A method for manufacturing the glass substrate 10 in the present embodiment includes: a preparation step of preparing a glass plate as the glass substrate before the mark 100 is formed; and an irradiation step of irradiating the surface of the glass substrate with laser light to form the mark 100, and manufacturing the glass substrate 10.

At the preparation step, after melting a glass raw material, the glass plate is manufactured by causing the glass raw material to be in a glass state by an optional glass molding method such as a float method, a fusion method, or an ingot forming method, and the glass plate is processed to have the shape of the glass substrate thereafter. In the example of the present embodiment, the glass substrate has a disc shape, so that the glass is cut out in a circular shape by optional means such as slicing and circular shape cutting, for example, to form the glass plate having a circular shape. The glass plate cut out in the circular shape is subjected to chamfering processing for an end face and grinding and polishing processing for a surface. Herein, when surface roughness (Ra) in the vicinity of the region in which the dot is formed deviates from a preferable range, additional processing can be performed on a target region. That is, at an optional timing after the grinding and polishing processing of the surface and before machining with a laser, surface treatment such as additional local polishing or medical fluid processing can be performed on the target region. Examples of local polishing include additional polishing performed on a region in the vicinity of an engraved seal using a polishing pad including a small head, or fine processing of the surface with a medical fluid such as hydrofluoric acid, laser light, or plasma. By performing such local processing, the dot 110 can be formed by laser machining on the glass substrate on which laser machining is hardly performed. The glass plate that has been subjected to the designed steps is further subjected to a cleaning and inspecting step to have desired Ra, and the preparation step is completed.

At the irradiation step, processing of forming the dot 110 by irradiating the surface of the glass plate with laser light is repeatedly performed to form the mark 100 constituted of a plurality of the dots 110 on the surface of the glass plate. At the time of emitting laser light, a metal film or a resin film having a high absorption coefficient may be applied to facilitate laser machining or prevent attachment of scattered matter. The laser light is emitted to a glass surface via various optical appliances (described later) from a light source. The glass surface is moved in a direction perpendicular to the Z-direction by using a scanner, but may be moved by using a stage and the like.

In the present embodiment, one dot 110 is formed by one laser irradiation trace. Herein, one laser irradiation trace indicates an irradiation trace formed by emitting laser light once. The laser light may be emitted to the same point multiple times, or may be emitted while shifting a position at fixed pitches.

In the present embodiment, the dot 110 is formed by performing ablation processing on the glass surface by an excimer laser. In this case, the dot 110 is formed without causing a crack on the glass surface. Manufacturing device for glass substrate

FIG. 14 is a schematic diagram of a manufacturing device for the glass substrate according to the present embodiment. FIG. 14 illustrates a device used at the irradiation step described above. As illustrated in FIG. 14, this glass manufacturing device 1 according to the present embodiment includes a laser oscillator 2, a mask 3, a mirror 4, and a condensing lens 5.

The laser oscillator 2 is a laser that oscillates laser light B1. That is, the laser oscillator 2 is a light source of the laser light B1. The laser oscillator 2 is, for example, an excimer laser that oscillates light using a light source having any wavelength selected from the group consisting of wavelengths of 193 nm, 248 nm, 308 nm, and 351 nm. That is, the laser oscillator 2 oscillates a pulse laser beam by pulsed discharge. A shape of the laser light B1 (beam shape) in a plan view viewed from a direction perpendicular to an optical path is, for example, a rectangle having long sides of 4 mm and short sides of 2 mm.

The mask 3 blocks part of the laser light B1 to change the beam shape. A position of the mask 3 is merely an example, and the mask 3 may be disposed on the optical path from the laser oscillator 2 to the condensing lens 5. A transmission pattern of the mask 3 will be described later.

The mirror 4 is, for example, a galvanometer mirror, and changes a direction of the optical path of laser light B2. The mirror 4 is not necessarily disposed, or a plurality of the mirrors 4 may be disposed.

The condensing lens 5 condenses the laser light B2, and adjusts a spot diameter of laser light B3. The spot diameter of the laser light B3 may be adjusted so that the dot diameter D is about 100 μm.

Due to this, the laser light B3 is emitted to the glass surface 10A, and the dot 110 according to the present embodiment is formed.

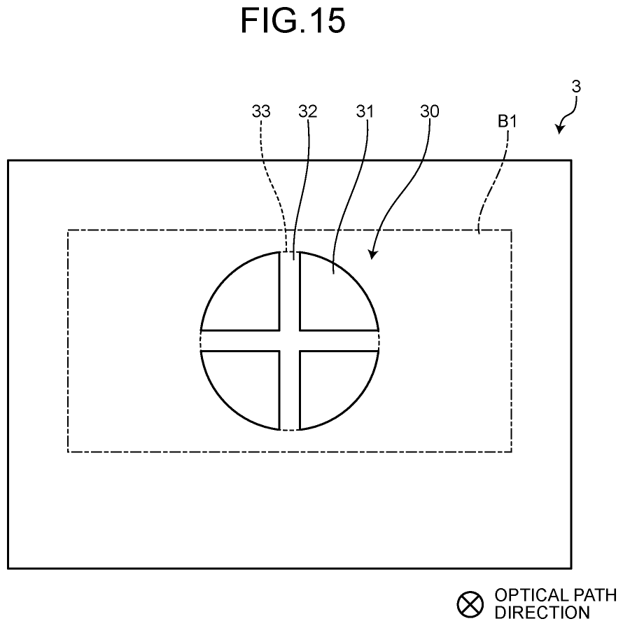

FIG. 15 is a schematic plan view of the mask according to FIG. 14. More specifically, FIG. 15 is a plan view of the mask 3 viewed from an optical path direction of the laser light B1. As illustrated in FIG. 15, the mask 3 of the glass manufacturing device 1 according to the present embodiment includes a transmission pattern 30. The transmission pattern 30 is disposed at a position overlapping the laser light B1 in a plan view in the optical path direction of the laser light B1. The transmission pattern 30 includes a transmission part 31 and a shielding part 32. The transmission part 31 is a portion through which the laser light B1 is transmitted, and the shielding part 32 is a portion that blocks the laser light B1. Shapes of the transmission part 31 and the shielding part 32 are the same as those of the indentation part 111 and the projecting part 112 of the dot 110, respectively. That is, the transmission pattern 30 has the same shape as that of the dot 110. The shielding part 32 extends at a position overlapping a contour 33 of the transmission pattern 30 or on an inner side than the contour 33 in a plan view viewed from a direction along the optical path of the laser light. In the present embodiment, the shielding part 32 extends from a position overlapping an inner side of the contour 33 of the transmission pattern 30 toward the inner side than the contour 33 in a plan view viewed from the direction along the optical path of the laser light. In the example of FIG. 15, a shape of the transmission pattern 30 is four quadrants in a plan view in the optical path direction. The four quadrants are arranged so that the shape of the transmission pattern 30 is rotationally symmetric while right angles are oriented inward. In the example of FIG. 15, the shielding part 32 has a cross shape extending from four positions overlapping the contour 33 toward the inner side than the contour 33. Due to this, a portion of the laser light B1 other than the transmission part 31 is blocked by the mask 3, so that a beam shape of the laser light B2 and B3 passed through the mask 3 is the same as the shape of the indentation part 111. Accordingly, the dot 110 according to the present embodiment can be formed on the glass substrate 10.

### Effects

As described above, the glass substrate 10 according to a first aspect of the present invention is the glass substrate 10 in which the mark 100 constituted of the dots 110 is disposed on the surface 10A, the dot 110 includes the indentation part 111 depressed from the surface 10A and the projecting part 112 projecting from the indentation part 111 in the thickness direction (Z-direction) of the glass substrate 10, and the projecting part 112 extends at a position overlapping the contour 113 of the dot 110 or on the inner side than the contour 113. Due to this, the dot 110 has external appearance including unevenness, and it can be considered that a shadow tends to be generated at the time of reading the dot 110, or light tends to be reflected. Accordingly, a contrast difference of the dot 110 is increased, so that the mark 100 can be easily read.

The glass substrate 10 according to a second aspect of the present invention is the glass substrate 10 according to the first aspect of the present invention in which the projecting part 112 extends from a position overlapping the contour 113 of the dot 110 toward the inner side of the contour 113. Due to this, the dot 110 has external appearance including unevenness, so that a shadow tends to be generated at the time of reading the dot 110, or light tends to be reflected. Accordingly, a contrast difference of the dot 110 is increased, so that the mark 100 can be easily read.

The glass substrate 10 according to a third aspect of the present invention is the glass substrate 10 according to the first aspect or the second aspect of the present invention, in which assuming that the peripheral edge on the outer side among the peripheral edges 111a of the indentation part 111 is the outer peripheral edge 111a1 and the peripheral edge other than the outer peripheral edge 111a1 among the peripheral edges 111a of the indentation part 111 is the inner peripheral edge 111a2, a ratio A of the length of the inner peripheral edge 111a2 to the length of the outer peripheral edge 111a1 (length of the inner peripheral edge 111a2/length of the outer peripheral edge 111a1) satisfies 0.2<A<50. Due to this, a degree of unevenness of the dot 110 becomes sufficient, so that the mark 100 can be read more easily.

The glass substrate 10 according to a fourth aspect of the present invention is the glass substrate 10 according to any one of the first aspect to the third aspect of the present invention in which the projecting part 112 passes through at least two points on the contour 113. Also in this case, the mark 100 can be easily read.

The glass substrate 10 according to a fifth aspect of the present invention is the glass substrate 10 according to the fourth aspect of the present invention in which the projecting part 112 passes through at least four points on the contour 113. Also in this case, the mark 100 can be easily read.

The glass substrate 10 according to a sixth aspect of the present invention is the glass substrate 10 according to any one of the first aspect to the fifth aspect of the present invention in which the depth H of the indentation part 111 is equal to or smaller than 30 μm. Due to this, differences in the unevenness of the mark 100 are increased, so that the mark 100 can be read more easily.

As described above, the manufacturing device 1 for the glass substrate 10 according to a seventh aspect of the present invention is the manufacturing device 1 that disposes the mark 100 constituted of the dots 110 on the surface 10A of the glass substrate 10, and includes the laser oscillator 2 that oscillates laser light for forming the dot 110 on the glass substrate 10, and the mask 3 disposed on the optical path of the laser light connecting the laser oscillator 2 with the glass substrate 10. The mask 3 includes the transmission pattern 30 including the transmission part 31 through which the laser light is transmitted and the shielding part 32 that blocks the laser light, and the shielding part 32 extends at the position overlapping the contour 33 of the transmission pattern 30 or on the inner side than the contour 33 in a plan view viewed from the direction along the optical path of the laser light. Due to this, it is possible to provide the glass substrate 10 with which the mark 100 can be easily read.

The manufacturing device 1 for the glass

substrate 10 according to an eighth aspect of the present invention is the manufacturing device 1 for the glass substrate 10 according to the seventh aspect of the present invention in which the laser oscillator 2 is an excimer laser. Due to this, it is possible to provide the glass substrate 10 with which the mark 100 can be easily read.

### EXAMPLES

Next, the following describes examples.

### First Experiment

Table 1 is a table indicating an example 1 to an example 10 according to a first experiment. In the first experiment, laser light was emitted to form a dot while the number of times of emission (the number of shots) of the laser light was set to be 10 shots.

TABLE 1

| | Dot external | | Number of | Matching |
|---|---|---|---|---|
| Example | appearance | A | shots | level |
| Example 1 | Circular | 0 | 10 | 7.0 |
| | shape | | | |
| Example 2 | [symbol] | 1.28 | 10 | 68.3 |
| Example 3 | | 1.27 | 10 | 68.3 |
| Example 4 | | 1.26 | 10 | 50.4 |
| Example 5 | | 1.29 | 10 | 11.1 |
| Example 6 | [symbol] | 0.34 | 10 | 29.9 |
| Example 7 | [symbol] | 0.69 | 10 | 63.5 |
| Example 8 | [symbol] | 7.94 | 10 | 62.4 |
| Example 9 | [symbol] | 13.5 | 10 | 80.8 |
| Example 10 | [symbol] | 16.8 | 10 | 79.0 |

### Example 1

In the example 1, a glass substrate having a diameter of 300 mm and a thickness of 1.0 mm was irradiated with laser light, and a dot was formed to have external appearance of a circular shape. That is, the external appearance of the dot according to the example 1 is a circle, and includes no projecting part. In other words, in the example 1, a circular-shaped indentation part is formed over the entire region of the dot. Irradiation conditions for the laser light was wavelength: 193 nm, output: 4 mJ, and frequency: 200 Hz, and the number of times of emission (the number of shots) of the laser light was set to be 10 shots. A diameter of a contour of the dot was 100 μm. In the example 1, the dot was formed not to have a projecting part, so that there is no projecting part as indicated by Table 1.

### Example 2

In the example 2, the dot was formed under the same conditions as those in the example 1 except the external appearance of the dot. As indicated by Table 1, the dot according to the example 2 has external appearance as a dot having a circular arc-shaped contour and including four quadrant-shaped indentation parts and a cross-shaped projecting part passing through between the indentation parts. In the example 2, the dot was formed by setting the ratio A of a length of an inner peripheral edge to a length of an outer peripheral edge of the indentation part (length of the inner peripheral edge/length of the outer peripheral edge) as in Table 1.

### Example 3 to Example 5

In the example 3 to the example 5, the dot was formed by the same method as that in the example 2 except that the ratio A was set as in Table 1.

### Example 6

In the example 6, as indicated by Table 1, the dot was formed by the same method as in the example 2 except that the dot was caused to have external appearance as a dot having a circular arc-shaped contour in which one projecting part was formed to extend from one position overlapping the contour of the dot toward an inner side than the contour in the lateral direction, and a remaining portion was an indentation part, and the number of shots and the ratio A were set as in Table 1.

### Example 7

In the example 7, as indicated by Table 1, the dot was formed by the same method as in the example 2 except that the dot was caused to have external appearance as a dot having a circular arc-shaped contour and including two semicircular-shaped indentation parts and a belt-shaped projecting part passing through between the indentation parts, and the number of shots and the ratio A were set as in Table 1.

### Example 8

In the example 8, as indicated by Table 1, the dot was formed by the same method as in the example 2 except that the dot was caused to have external appearance as a dot having a circular arc-shaped contour in which five projecting parts were formed in each of the vertical direction and the lateral direction and a remaining portion was an indentation part, and the number of shots and the ratio A were set as in Table 1.

### Example 9

In the example 9, as indicated by Table 1, the dot was formed by the same method as in the example 2 except that the dot was caused to have external appearance as a dot having a circular arc-shaped contour in which seven projecting parts were formed in each of the vertical direction and the lateral direction and a remaining portion was an indentation part, and the number of shots and the ratio A were set as in Table 1.

### Example 10

In the example 10, as indicated by Table 1, the dot was formed by the same method as in the example 2 except that the dot was caused to have external appearance as a dot having a circular arc-shaped contour in which eleven projecting parts were formed in each of the vertical direction and the lateral direction and a remaining portion was an indentation part, and the number of shots and the ratio A were set as in Table 1.

### Evaluation

In the first experiment, the dot in each example was read by Keyence SRX300, and a matching level was measured. The matching level was measured by setting a distance between the mark and the reader to be 8 cm, and setting a reading angle with respect to the surface of the glass substrate to be 30°, for example. In the first experiment, the matching level equal to or larger than 10 was determined to be acceptable, and the matching level smaller than 10 was determined to be unacceptable.

As indicated by Table 1, the matching level was determined to be acceptable in the example 2 to the example 10 as examples in which the projecting part extending from the contour of the dot toward a radially inner side was disposed, and the matching level was determined to be unacceptable in the example 1 as a comparative example in which no projecting part is disposed. It can be found that the mark can be easily read by causing the dot to have the indentation part and the projecting part as described above.

### Second Experiment

Table 2 is a table indicating an example 11 to an example 23 according to a second experiment. In the second experiment, laser light was emitted to form the dot while the number of times of emission (the number of shots) of the laser light was set to be 30 shots.

TABLE 2

| | Dot external | | Number of | Matching |
|---|---|---|---|---|
| Example | appearance | A | shots | level |
| Example 11 | Circular | 0 | 30 | 59.0 |
| | shape | | | |
| Example 12 | [symbol] | 1.28 | 30 | 78.9 |
| Example 13 | | 1.27 | 30 | 80.3 |
| Example 14 | | 1.26 | 30 | 80.5 |
| Example 15 | | 1.29 | 30 | 71 |
| Example 16 | [symbol] | 2.56 | 30 | 83.0 |
| Example 17 | [symbol] | 4.99 | 30 | 73.4 |
| Example 18 | [symbol] | 0.34 | 30 | 60.0 |
| Example 19 | [symbol] | 0.69 | 30 | 78.0 |
| Example 20 | [symbol] | 7.94 | 30 | 69.6 |
| Example 21 | [symbol] | 13.5 | 30 | 78.2 |
| Example 22 | [symbol] | 16.8 | 30 | 71.2 |
| Example 23 | [symbol] | 1.20 | 30 | 71.1 |

### Example 11

In the example 11, the dot was formed by the same method as that in the example 1 except that the number of shots was set as in Table 2.

### Example 12 to Example 15

In the example 12 to the example 15, the dot was formed by the same method as that in the example 2 except that the number of shots and the ratio A were set as in Table 1.

### Example 16

In the example 16, as indicated by Table 2, the dot was formed by the same method as in the example 2 except that the dot was caused to have external appearance as a dot having a circular arc-shaped contour in which two projecting parts were formed in each of the vertical direction and the lateral direction and a remaining portion was an indentation part, and the number of shots and the ratio A were set as in Table 1.

### Example 17

In the example 17, as indicated by Table 2, the dot was formed by the same method as in the example 2 except that the dot was caused to have external appearance as a dot having a circular arc-shaped contour in which three projecting parts were formed in each of the vertical direction and the lateral direction and a remaining portion was an indentation part, and the number of shots and the ratio A were set as in Table 1.

### Example 18

In the example 18, as indicated by Table 1, the dot was formed by the same method as in the example 2 except that the dot was caused to have external appearance as a dot having a circular arc-shaped contour in which one projecting part was formed to extend from one position overlapping the contour of the dot toward an inner side of the contour in the lateral direction, and a remaining portion was an indentation part, and the number of shots and the ratio A were set as in Table 1.

### Example 19

In the example 19, as indicated by Table 1, the dot was formed by the same method as in the example 2 except that the dot was caused to have external appearance as a dot having a circular arc-shaped contour and including two semicircular-shaped indentation parts and a belt-shaped projecting part passing through the indentation parts, and the number of shots and the ratio A were set as in Table 1.

### Example 20

In the example 20, as indicated by Table 1, the dot was formed by the same method as in the example 2 except that the dot was caused to have external appearance as a dot having a circular arc-shaped contour in which five projecting parts were formed in each of the vertical direction and the lateral direction and a remaining portion was an indentation part, and the number of shots and the ratio A were set as in Table 1.

### Example 21

In the example 21, as indicated by Table 1, the dot was formed by the same method as in the example 2 except that the dot was caused to have external appearance as a dot having a circular arc-shaped contour in which seven projecting parts were formed in each of the vertical direction and the lateral direction and a remaining portion was an indentation part, and the number of shots and the ratio A were set as in Table 1.

### Example 22

In the example 22, as indicated by Table 1, the dot was formed by the same method as in the example 2 except that the dot was caused to have external appearance as a dot having a circular arc-shaped contour in which eleven projecting parts were formed in each of the vertical direction and the lateral direction and a remaining portion was an indentation part, and the number of shots and the ratio A were set as in Table 1.

### Example 23

In the example 23, as indicated by Table 1, the dot was formed by the same method as in the example 2 except that the dot was caused to have external appearance as a dot having a circular arc-shaped contour, in which a projecting part includes a cross-shaped portion each line of which was formed in each of the vertical direction and the lateral direction, a circular portion formed at an intersecting point of the cross-shaped portion, and an indentation part as a remaining portion, and the number of shots and the ratio A were set as in Table 1.

### Evaluation

In the second experiment, the dot of each example was read by Keyence SRX300 under the same conditions as those in the first experiment, and the matching level was measured. In the second experiment, the matching level equal to or larger than 60 was determined to be acceptable, and the matching level smaller than 60 was determined to be unacceptable.

As indicated by Table 2, the matching level was determined to be acceptable in the example 11 to the example 23 as examples in which the projecting part extending from the contour of the dot toward the radially inner side was disposed, and the matching level was determined to be unacceptable in the example 10 as a comparative example in which no projecting part is disposed. It can be found that the mark can be easily read by causing the dot to have the indentation part and the projecting part as described above.

As indicated by Table 1 and Table 2, the matching level was improved in the example 11 to the example 23 in which the number of shots was set to be 30 as compared with each of the example 2 to the example 10 in which the dot having the same external appearance and A was formed while setting the number of shots to be 10. It can be found that the mark can be read more easily by increasing the number of shots.

According to the present invention, it is possible to provide the glass substrate with which the mark can be easily read.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A glass substrate, comprising:
a glass substrate having a surface and a mark comprising a plurality of dots such that the mark is formed on the surface of the glass substrate,
wherein each of the dots includes an indentation part as a portion depressed from the surface, and a projecting part projecting from the indentation part in a thickness direction of the glass substrate, and the projecting part extends at a position overlapping a contour of a respective one of the dots or on an inner side than the contour.

2. The glass substrate according to claim 1, wherein the projecting part extends from the position overlapping the contour of the respective one of the dots toward the inner side than the contour.

3. The glass substrate according to claim 1, wherein assuming that a peripheral edge on an outer side among peripheral edges of the indentation part is an outer peripheral edge and a peripheral edge other than the outer peripheral edge among the peripheral edges of the indentation part is an inner peripheral edge, a ratio A of a length of the inner peripheral edge to a length of the outer peripheral edge satisfies 0.2<A<50.

4. The glass substrate according to claim 1, wherein the projecting part passes through at least two points on the contour.

5. The glass substrate according to claim 4, wherein the projecting part passes through at least four points on the contour.

6. The glass substrate according to claim 1, wherein a depth of the indentation part is equal to or smaller than 30 μm.

7. A manufacturing device for a glass substrate, comprising:
a laser oscillator configured to oscillate laser light that forms a dot on a glass substrate; and
a mask disposed on an optical path of the laser light connecting the laser oscillator with the glass substrate,
wherein the manufacturing device is configured to dispose a mark comprising a plurality of dots on a surface of the glass substrate, the mask includes a transmission pattern including a transmission part through which the laser light is transmitted and a shielding part that blocks the laser light, and the shielding part extends at a position overlapping a contour of the transmission pattern or on an inner side than the contour in a plan view viewed from a direction along the optical path of the laser light.

8. The manufacturing device for the glass substrate according to claim 7, wherein the laser oscillator is an excimer laser.

9. The glass substrate according to claim 2, wherein assuming that a peripheral edge on an outer side among peripheral edges of the indentation part is an outer peripheral edge and a peripheral edge other than the outer peripheral edge among the peripheral edges of the indentation part is an inner peripheral edge, a ratio A of a length of the inner peripheral edge to a length of the outer peripheral edge satisfies 0.2<A<50.

10. The glass substrate according to claim 2, wherein the projecting part passes through at least two points on the contour.

11. The glass substrate according to claim 10, wherein the projecting part passes through at least four points on the contour.

12. The glass substrate according to claim 2, wherein a depth of the indentation part is equal to or smaller than 30 μm.

13. The glass substrate according to claim 3, wherein the projecting part passes through at least two points on the contour.

14. The glass substrate according to claim 13, wherein the projecting part passes through at least four points on the contour.

15. The glass substrate according to claim 3, wherein a depth of the indentation part is equal to or smaller than 30 μm.

16. The glass substrate according to claim 4, wherein a depth of the indentation part is equal to or smaller than 30 μm.

17. The glass substrate according to claim 5, wherein a depth of the indentation part is equal to or smaller than 30 μm.
